(19) United States
(12) Patent Application Publication
(10) Pub. No.: US 2017/0297060 A1
(43) Pub. Date: Oct. 19, 2017

(54) SCREENING SYSTEM WITH FEEDING SYSTEM, CONVEYING SYSTEM AND CONVEYING METHOD

(71) Applicant: Volkmann GmbH, Soest (DE)

(72) Inventors: Joachim Maas, Soest (DE); Christopher Tegelkamp, Soest (DE)

(21) Appl. No.: 15/488,869

(22) Filed: Apr. 17, 2017

(30) Foreign Application Priority Data
Apr. 18, 2016 (DE) 20 2016 002 402.8

(51) Int. Cl. B07B 1/38

(52) U.S. Cl. CPC B07B 1/38; B07B 2230/04

(57) ABSTRACT

A screening system for separating/screening a conveying medium formed as fluid, powder and/or bulk material comprising a screening system inlet, a screening system outlet, a screen between the inlet and outlet, a feeding system for feeding the medium upstream of the inlet and/or the screen, a transport path between the inlet means and the outlet means, which is delimited by a conveyor channel line, a flow-limiting means wherein the volume flow of the conveying medium can be changeably limited is arranged in or down-stream from the transport path that comprises a flat transport surface, which is formed as a flat metering plate and a metering plate edge forms the outlet means of the feeding system, the flow-limiting means comprises an outlet opening wherein the outlet opening size can be changed to change the volume flow of the medium, which passes through the outlet opening that is arranged at the end of a conveyor channel or line of the feeding system, the outlet opening is arranged between the conveyor channel or line and the outlet means, in particular upstream of or on the transport surface and an oscillation can be applied to the medium.

### FIELD OF THE INVENTION

The invention relates to a screening system with a feeding/charging system for feeding a conveying medium formed as fluid, powder and/or bulk material according to the features according to the preamble of claim 1. For example, the conveying medium is a granular product, which is to be fed to a product conveying system and/or to a product separating system. The product feeding system thereby comprises an inlet means, which can be formed in a hopper-like manner, for example, or which comprises a hopper and/or a tube. The conveying medium, thus the product, is integrated in the feeding system via the inlet means in order to establish a product flow. The feeding system further comprises at least one outlet means, through which the conveying medium leaves the feeding system again. Advantageously, the feeding system is designed in such a way that, from a fluidic/fluid-mechanical aspect, the outlet means can be connected to that device, to which the conveying means is to be fed.

The screening serves to mechanically separate or classify the bulk material, for instance according to particle or grain size. Based on the (pore) size of the openings of the screen, parts of the conveying medium are typically separated into those comprising oversized grain size and those comprising undersized grain size. The screening system comprises a screening system inlet, which in particular comprises a hopper and/or a tube, and at least one screening system outlet, through which parts of the bulk material leave the screening system, separated by grain size. Based on the conveying direction of the conveying medium, at least one screen is arranged in the screening system between the screening system inlet and the screening system outlet. The screen can have a circular or virtually circular or an angular/rectangular geometry. The screen can be arranged in a frame-like screen holder. For example at least one grain outlet, for instance an undersized grain outlet, is arranged downstream from the screen (based on the flow direction of the conveying medium. Upstream a oversized grain outlet can be provided.

The invention further relates to a conveying system for conveying a conveying medium formed as fluid, powder and/or bulk material, according to the features according to the preamble of claim 12.

The invention finally relates to a method for conveying a conveying medium according to claim 14 formed as fluid, powder and/or bulk material.

### TECHNOLOGICAL BACKGROUND

The processing, handling or packaging of granular products requires a technically sophisticated conveying. Oftentimes, a volume flow is created, in which the product then “flows”. Provided that the product is granular and thereby comprises a plurality of grain sizes, or provided that the product can break due to the stress while flowing, whereby product particles of different sizes are formed, a product separation is routinely required. Screening systems are suitable for this purpose. So that, on the one hand, the product separation runs effectively within the screening system and so that, on the other hand, the product flow is not interrupted, for instance by the formation of accumulation, screening systems are routinely made to move, wherein the kinetic energy of the moving screening system is transferred to the product, the product particles “jolt” or “wobble” and the likelihood for a formation of an accumulation in the product flow is reduced, the flow is thus improved. “flow” refers to the volume flow, thus the volume of the conveying medium conveyed per time and (cross sectional) surface. A common method for transferring kinetic energy to the product particles is oscillation stimulation. For example, the entire screening system can thereby be stimulated to oscillate. Depending on the nature of the product particles, it may be advantageous to stimulate the required oscillation via an (oscillation) source, for example by means of an ultrasonic source. Energy is thus coupled into the screening system and is transferred from there to the product, which leads to lower kinematic effects, which influence the flow behavior, inside the conveying medium. In spite of oscillation stimulation, bottlenecks in the flow rate, in particular upstream of or on the screen, happen again and again in response to the conveying of a conveying medium, whereby, in the worst case, the product flow can be interrupted. In addition, the screen is oftentimes only loaded in sections due to non-homogenous flow of the conveying medium. This is where the invention comes in.

### DESCRIPTION OF THE INVENTION

It is the object of the invention to specify measures, by means of which interferences or interruptions of the flow of the conveying medium are at least reduced. A reduction of interferences or interruptions of the flow of a conveying medium is solved by means of a screening system according to claim 1. The screening system comprises a feeding system.

The feeding system serves to feed a conveying medium formed as fluid, powder and/or bulk material, in particular in a conveying system and/or in a separating system or in a device, which is required for handling the conveying medium. Between the for example hopper-like inlet means of the feeding system and the for example line- or hopper-like outlet means, provision is made for a transport path, which can in particular be delimited by means of a conveyor channel or by means of a conveyor line. A flow-limiting means, by means of which the volume flow of the conveying medium can be limited in a changeable manner, is arranged upstream of, in or downstream from the transport path. An oscillation can be applied to the conveying medium. The oscillation can be a mechanical oscillation or a/low-frequency/oscillation. Alternatively or additionally, provision can be made for ultrasonic frequency stimulation. A plurality of stimulations and combinations of these stimulations and corresponding stimulation couplers can thus be provided. The oscillation frequency spectrum can be between approximately 0.5 Hz and approximately 50,000 Hz (1 Hz=1/second).

Interferences of the flow are thus already avoided when feeding the conveying medium, because, due to the fact that by applying (ultrasonic) oscillation to the conveying medium, the conveying medium or the dynamic behavior thereof, respectively, is disturbed in such a way that an accumulation of the conveying medium essentially does not occur. The feeding system can feed the conveying medium in a metered quantity, substantially constantly and substantially homogeneously to that device, which can be connected or is connected to the feeding system from a fluid-mechanical aspect. The feeding system can also be used as metering system or as metering aid in this respect. The inlet means of the feeding system can be formed as hopper and/or tube, which, in turn, has an inlet and an outlet side. A hopper pipe can be arranged on the hopper outlet side. The feeding system can be designed as conveyor component for production, transport, packaging or other plants/devices. An activation or deactivation, respectively, of the flow of the conveying medium can take place by activating the flow-limiting means and/or by activating/deactivating the oscillation generated by means of the feeding system.

The feeding system is designed such that the transport path and/or the flow-limiting means comprise at least one transport surface, which is in particular formed as metering plate. In the alternative, the transport path can open into a flat transport surface, which is in particular formed as flat metering plate of the flow-limiting means. In the case of the one alternative as well as in the case of the other alternative, the flat transport surface edge of the transport surface, in particular the metering plate edge or the plate flange, forms the outlet means of the feeding system. The product flow accordingly occurs as follows: The conveying medium reaches into the (hopper-like/or tube-like) inlet means. The conveying medium flows, “falls” or streams along the transport path, for instance through a conveyor channel, and reaches the metering plate. When the metering plate or the metering disk is stimulated with an (mechanic oscillation and/or low frequency oscillation and/or ultrasonic oscillation and/or combinations of these oscillations) oscillation, the metering plate or the metering disk vibrates and the formation of an accumulation of the conveying medium is avoided on the entire transport path and downstream therefrom. The conveying medium subsequently leaves the feeding system, in that it falls over the edge of the vibrating metering plate. From there, the substantially constant and homogenous flow of the conveying medium reaches into the device connected to the conveying medium.

The transport surface is preferably formed by a closed an uninterrupted surface. The transport surface can adjoin the metering disk or can be arranged on the metering disk. The transport surface of the feeding system can optionally have one or a plurality of openings. According to an alternative, the transport surface can be formed as (exchangeable) screen. The transport surface can be formed in a plurality of parts, the transport surface can for example comprise a first transport surface portion and at least a second transport surface portion, wherein the position of the transport surface portions, in particular the position of the transport surface portions relative to one another, can be capable of being changed. The transport surface portions can form a plurality of planes of the transport surface. Provision can be made for example for a first transport surface portion, which consists of segments of a circle, as well as a transport surface portion arranged directly thereabove, which consists of segments of a circle, which are arranged so as to be offset. By varying the offset, the size and/or geometry of the transport surface and/or the size or geometry of the outlet opening can be capable of being influenced. The flat transport surface can have an oval, (circular) round, (rectangular) angular layout. The oscillation of the metering disk can be oriented arbitrarily, i.e. comprising oscillation directional components, which on average comprise all (spatial) directions. The oscillation stimulation can take place in such a way that the oscillation is formed from at least one preferred oscillation directional component or that at least one preferred directional component is comprised. A preferred directional component can for example be located in the plane of the transport surface (metering disk plane). A preferred oscillation directional component can point out of the plane of the transport surface, for example vertically. Provision can be made for at least one rotational oscillation directional component, which can be stimulated for instance by a rotary drive or by a rotary oscillation actuating element, respectively, in particular acting on the metering disk. A vertical oscillation of transport surface/metering disk can be provided, for instance by stimulation by means of shaker/wobbler.

Provision is made for the flow-limiting means to comprise an outlet opening, in particular an outlet gap, or to be formed therefrom. The outlet opening size, in particular the outlet gap dimension, can be changed to change the volume flow of the conveying medium, which passes through the outlet opening (outlet gap). When changing the size of the opening (outlet gap), provision can be made for a controlling and/or regulating. The outlet opening (outlet gap) is arranged at the end of a conveyor channel (conveyor line) of the feeding system. The outlet opening (outlet gap) is arranged between the conveyor channel (conveyor line) and the outlet means. Particular advantages result, when the outlet opening is arranged directly upstream of or on the transport surface. The product flow is thus also determined by the geometry of the outlet opening and a product flow control/regulation takes place by varying all or a selection of the following parameters: outlet opening geometry (outlet gap dimension), intensity/frequency/modulation direction of the oscillation stimulation and actuating element/effect of the oscillation stimulation (coupling of the actuating element to the entire system or only component by component, for example to the metering plate).

The outlet opening size can preferably be changed by varying a distance, for instance the distance between a conveyor channel (conveyor line) and the transport surface. The conveyor channel (conveyor line) thereby leads to the transport surface of the feeding system. The variation of the distance can control the product flow in the direction of the transport surface. A homogenous product flow downstream from the outlet opening is ensured by means of the oscillation-initiated distribution of the conveying medium on the transport surface. In that the distance is chosen to be very small or virtually negligibly small, the product flow can be interrupted at least temporarily, for instance if cleaning or maintenance work becomes necessary downstream from the feeding system. To ensure a product flow, which is as homogenous and constant as possible, provision can be made for a control circuit, which can regulate the volume flow and thereby control the outlet opening size and, if necessary, further states/parameters.

The feeding system can have its own, in particular controllable and/or regulatable feeding system oscillation system. This can be a feeding system oscillation ultrasonic source, which transfers an oscillation, in particular ultrasonic oscillation, to the conveyor channel system, in particular to the inlet means, a conveyor channel or a conveyor line, to the flow-limiting means, and/or the outlet means. A piezoelectric actuating element can be used to generate oscillation or an unbalanced mass or—if ultrasonic oscillations are to be involved—a sonotrode. The oscillation can be transferred to the conveying medium via the feeding system, in particular via the inlet means, the conveyor channel or the conveyor line, via the flow-limiting means and/or the outlet means. A corresponding control circuit can comprise a control for the feeding system-oscillation system. For this purpose, provision can be made for a measured value acquisition, which acquires measured values, such as, for instance, geometric sizes, flow values, oscillation data, time data, temperature data and further data or values, respectively, which are useful for the operation of the system. The acquired values/data can be capable of being transferred to the control/regulating technology.

The screening system is suitable for screening a conveying medium formed as fluid, powder and/or bulk material. The screening system comprises a screening system inlet, in particular comprising a hopper and/or tube, and at least one screening system outlet, as well as at least one screen, which is preferably circular or virtually circular or angular or rectangular and which is arranged between the screening system inlet and the screenings system outlet. The screening system comprises a feeding system as described herein, which, based on the conveying direction of the conveying medium, is arranged upstream of the screening system inlet and/or upstream of the screen. A mechanical separating method for size separation or for classifying the bulk material can be converted by means of the screening system. The screen of the screening system can be arranged in a frame-like screen holder. Provision can be made for a plurality of screens arranged downstream from one another or for a multi-stage screen formed from a plurality of screen parts. Based on the conveying medium flow direction, at least one grain outlet, for instance an undersized grain outlet is located downstream from the screen. An oversized grain outlet can be provided upstream. The screening becomes more effective due to the effect of the oscillation, an accumulation of the conveying medium is avoided. In addition, the screen is more effectively loaded with the conveying medium. The above-described gap dimension, the diameter of involved hopper openings, the dimensions in particular of the metering plate/metering disk and the oscillation parameters (frequency, amplitude, modulation, direction) inside the screening system influence the flow of the conveying medium or the product flow, respectively, in or through the screening system. Every factor can be used as variable for controlling/regulating the product flow. The parameters on the metering disk can be fixed, the oscillation state on the screen can change with the product occupation of the screen.

The screening system advantageously comprises a screening system oscillation system. A mechanical oscillation can be applied to the conveying medium or the conveying medium and one or all components, respectively, of the screening system, by means of the oscillation system. The oscillation can lie in the frequency range of between approximately 0.5 Hz and approximately 50,000 Hz, for example in the infrasonic or ultrasonic or low frequency range. The oscillation of the screening system-oscillation system can be capable of being transferred to the feeding system of the screening system or to all or individual components, respectively, of the feeding system, especially if the oscillation is within the low frequency range or if a low frequency portion is comprised. Provision can be made for an oscillation to be applied to the screen (ultrasonic oscillation and/or low frequency oscillation and/or mechanical oscillation). For this purpose, provision can be made for an oscillation generator, e.g. an ultrasonic generator which transfers the (additional ultrasonic) oscillation to the screen and from there to the conveying medium (at least proportionately), for instance via a coupling ring, which is arranged on the screen. However, the oscillation can also be applied to another component of the screening system, for instance the screening system or feeding system housing, insofar as provided in each case. The flow-limiting means (metering plate) of the feeding system can in particular be capable being oscillated via the screening system-oscillation system. Provision can optionally be made for two or a plurality of oscillation systems, namely a feeding system-oscillation system and a screening system-oscillation system, in particular one or a plurality of ultrasonic oscillation systems. Provision can be made for a screen moving system, which in particular stimulates the driving (metering) oscillation and which effects a linear and/or rotating movement of the conveying medium, for instance by means of an unbalanced mass or actuating element assigned to the screen or a mass element (see below).

According to an embodiment, provision can be made for at least one mechanical coupling, which can in particular be controlled and/or regulated, by means of which mechanical oscillations, in particular ultrasonic oscillations, can be transferred from the feeding system to the screening system inlet, the screening system outlet and/or to the screen of the screening system. In the alternative or cumulatively, (ultrasonic) oscillations can be transmitted from the screening system inlet, the screening system outlet and/or the screen of the screening system to the feeding system by means of the mechanical coupling. The oscillations can also be capable of being transferred from other or further components of the screening system. A transfer of the oscillation stimulation from the feeding system or to the feeding system thus takes place. In a preferred embodiment, the oscillation stimulation of an (ultrasonic) screening system is transferred to the feeding system. In connection with the effect of the feeding system, which is to be metered, a homogenized and substantially interruption-free conveying medium flow can thus be adjusted.

Provision can (in the alternative) also be made for at least one uncoupling, in particular if the screening system and the feeding system connected thereto in each case have their own oscillation system. By means of the uncoupling, mechanical oscillations, in particular ultrasonic oscillations, can be blocked mechanically between the feeding system and further components of the screening system, for instance in order to as to avoid oscillation-related material deteriorations in components of the systems.

The screening system can comprise at least one mass element, for instance an oscillating mass, to which the screening system is connected/fastened. The mass element can be set up on the ground, for example by means of cushioned support elements. The mass element can be coupled, in particular mechanically, to the screening system-oscillation system. The mass element forms an oscillation-stimulatable (counter) weight or an inertial body, whereby (low-frequency) oscillations can be transferred to components of the screening system. The screen can be coupled to an (ultra or infra)sonic actuator.

The screening system—as well as the feeding system—can comprise a housing. The (screening system) housing can be formed in a plurality of parts or modularly, respectively. Provision can be made between the (screening system) housing parts for flange or clamping connections, whereby the housing parts can be connected to one another, in particular so as to form a seal. The housing can have cylindrical geometries at least in sections. Provision can be made in the housing for a window, so that the product flow can be seen by the user outside of the housing.

The housing can be capable of being stimulated to oscillate or so as to be free from oscillation. According to a preferred embodiment, the metering plate or metering disk of the feeding system is mechanically coupled to the housing, which can be stimulated to oscillate, in such a way that the oscillation can be transferred from the screening system housing or from the mass element to the feeding system or to the metering plate, respectively.

In particular if a highly compact design is advantageous, provision can be made for the flow-limiting means, which comprise the metering plate, of the feeding system, to be arranged in or on the screen or in the area of the screen of the screening system.

With regard to a further optimization of the product flow, it can be provided that provision is made for a positioning means, which can be arranged upstream of and/or downstream from the feeding system for positioning the volume flow. The positioning means can be formed as feeding hopper. The positioning means contributes to a homogenous distribution of the conveying medium on the screen even outside of the feeding system. Provision can optionally be made for the screen to comprise a substantially impermeable recess (impermeable for the conveying medium), wherein the conveying medium, which leaves the feeding system, initially hits the recess and can be distributed evenly from there, for instance by means of the oscillation stimulation, to the permeable part of the screen.

A reduction of interferences or interruptions of the flow of a conveying medium is further attained by means of a conveying system according to claim 12. The conveying system is suitable to convey a conveying medium formed as fluid, powder and/or bulk material. According to the invention, the conveying system comprises a screening system described herein or a feeding system described herein. The conveying system can preferably have a modular construction.

All of the systems described herein, i.e. the feeding system, the screening system and/or the conveying system, can be designed in such a way that the conveying medium (bulk material) can be conveyed in an environment, which contains at least an inert fluid and which is preferably closed. The inert fluid can be formed as inert gas, thus for example as weakly reacting (noble) gas. The device can comprise a substantially gas-tight housing or at least a substantially gas-tight channel, in which an inert gas atmosphere can be created. Provision can thus be made for sealing means for sealing the inert gas atmosphere against the external atmosphere or against the environment, respectively.

A reduction of interferences or interruptions of the flow of a conveying medium is further attained by means of a method according to claim 14. The method serves to convey a conveying medium formed as fluid, powder and/or bulk material. In a method step, the conveying medium is fed or metered in that the flow of the conveying medium is limited on the conveying path of the conveying medium, in that the conveying medium is conveyed through a conveyor passage against a conveyor barrier, wherein the size/shape of the conveyor passage can be changed and wherein mechanical oscillation, in particular ultrasonic oscillation, can be applied to the conveyor passage and/or to the conveyor barrier, which can be transferred to the conveying medium. The conveyor passage can comprise a (changeable) outlet opening or a (changeable) outlet gap, respectively, for instance a flow-limiting means as described herein. The gap can be arranged between a conveyor channel or hopper, respectively, and the conveyor barrier. The conveyor barrier can comprise a transport surface described herein or a (oscillating, vibrating) metering disk.

The size, design, material selection and technical conception of the above-mentioned components as well as of the components, which are claimed and described in the exemplary embodiments, which are to be used according to the invention, are not subject to any special exceptions, so that the selection criteria known in the area of application can be used without limitation.

Further details, features and advantages of the subject matter of the invention follow from the subclaims as well as from the following description and the corresponding drawing in which an exemplary embodiment of a screening system with feeding system and of a screening system is illustrated—in an exemplary manner. Individual features of the claims or of the embodiments can also be combined with other features of other claims and embodiments.

### BRIEF DESCRIPTION OF THE FIGURES

FIG. 1 shows a feeding system in a schematic view,

FIG. 2 shows a screening system in a (schematic) sectional view,

FIG. 3 shows a screening system in a perspective view according to FIG. 2 and

FIG. 4 shows a top view on the screening system according to FIG. 2.

### DETAILED DESCRIPTION OF EXEMPLARY EMBODIMENTS

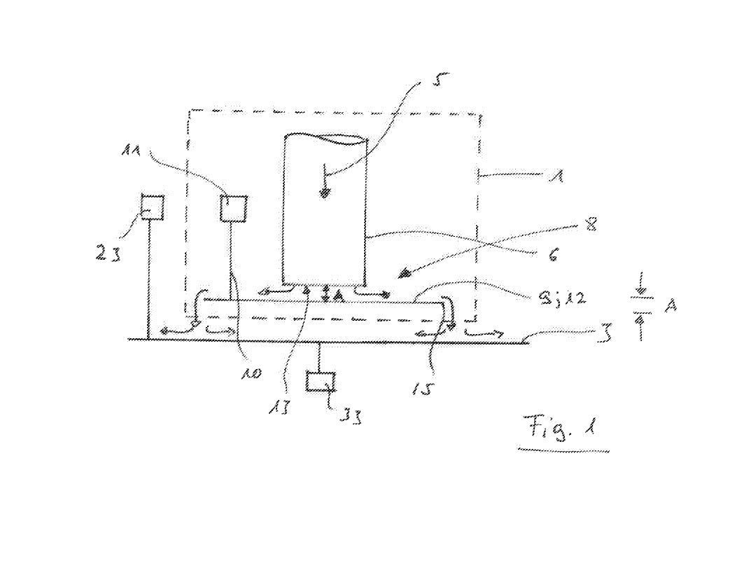

A schematic and highly simplified illustration of a feeding system 1 can be gathered from FIG. 1. A bulk material, for example, can be fed to a further device, for instance a screening system comprising a screen 3, by means of the feeding system 1. Only the screen 3 of the screening system is illustrated in outlines in FIG. 1. An ultrasonic oscillation system 33 can be arranged on or coupled to the screen 3, respectively. The feeding system 1 is located in the housing 2. The feeding system 1 comprises an inlet means 4. From there, the bulk material is transported via a transport path 5 through the feeding system 1. Provision can be made inside the feeding system 1 for a transport aid in the form of a fluid stream (gas, air, vacuum conveyor) or a mechanical transport aid. The transport of the bulk material can also be supported by the weight force acting on the bulk material. The transport path 5 is symbolized by arrows in FIG. 1. From the inlet means 4, the bulk material reaches into a conveyor channel 6. Based on the transport direction of the bulk material, a flow-limiting means 8 comprising a conveyor barrier 7 is located downstream from the conveyor channel 6. The volume flow of the bulk material can be changed with the help of the flow-limiting means 8.

The conveying carrier 7 is formed as metering plate 9 and comprises a transport surface 12 for the bulk material. The metering plate 9 can be formed in a rectangular or virtually rectangular manner and it is arranged above the screen 3. Provision can also be made for a round or virtually round or for an oval or virtually oval shape of the metering plate 9. A feeding system-oscillation system 11 is connected to the metering plate 9 via a mechanical coupling 10. The feeding system-oscillation system 11 generates an oscillation (ultrasonic oscillation and/or low frequency oscillation and/or mechanical oscillation and/or combinations thereof), which is transferred to the metering plate 9. The oscillation stimulation can take place via a piezoelectric or electromagnetic or mechanical transducer.

The distance A between conveyor channel 6 and metering plate 9 can be changed (mechanically). This can take place in that the position of the metering plate 9 is changed relative to the end 13 of the conveyor channel 6. In the alternative or cumulatively, the position of the conveyor channel 6 can be changed relative to the metering plate 9. For this purpose, provision can be made for a shiftable sleeve in the end area of the conveyor channel 6. The change in position of metering plate 9 or conveyor channel 6 can take place manually or (electro)mechanically, for example by means of an actuator.

An outlet opening formed as outlet gap 14 is formed by means of the distance A between conveyor channel 6 and metering plate 9, and by changing the distance A between channel 6 and plate 9, the size of outlet opening/outlet gap 14 is changed. The flow of the bulk material can thus be regulated by means of the feeding system 1.

In the case of the embodiment shown in FIG. 1, an oscillation, which is transferred into a kinetic energy in the bulk material, is applied to the bulk material by means of the metering plate 9 by means of the oscillation system 11. The bulk material vibrates (with the plate) and thus moves on the metering plate 9 in the direction of the plate flange 15. The flange 15 forms the transport surface edge (15) and thus the outlet means 16 of the feeding system 1. The bulk material leaves the feeding system 1 via the outlet means 16 (formed as hopper or comprising a hopper) and flows or falls onto the screen 3.

According to an embodiment, which is not illustrated in FIG. 1, the feeding-oscillation system 11 can also be connected or coupled, respectively, to the housing 2 of the feeding system 1. As a result, it is not only the metering plate 9, which is fastened in the housing 2, which vibrates, but also the conveyor channel 6 and the housing 2. In that virtually the entire feeding system 1 thus vibrates, the oscillation is applied to the bulk material virtually across the entire transport path 5.

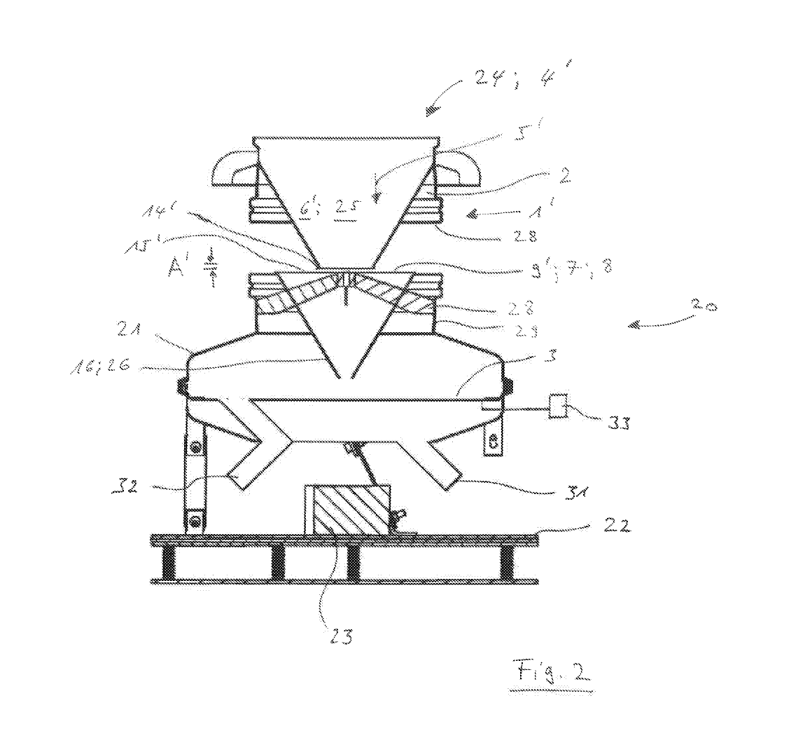

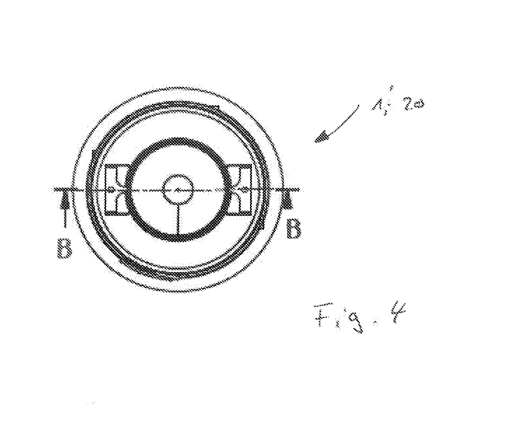

FIG. 2 shows a vertical sectional view of a screening system 20, in which a round or virtually round screen 3 is fastened in a screen container 21. In a top view, the screening system 20 would have a substantially round geometry (FIG. 4). The housing 29 of the screening system 20 comprises the screen container 21 and is fastened to a mass element 22. A screening system-oscillation system 23 for generating oscillation (approx. 0.5 Hz to 50,000 Hz), which applies a (low-frequency) oscillation to the screening system 20, which causes the driving metering oscillation, is arranged on the mass element 22. The oscillation is transferred to essential components (21, 22, 24, 25, 26, 27, 28) of the screening system 20, in particular to the metering plate 9 and/or the screen 3, from there to the bulk material, which is to be separated with respect to the bulk material grain size in the screening system 20 by means of the screen 3. In addition, an ultrasonic oscillation coupling can be capable of being activated via an ultrasonic generator 33, by means of which an ultrasonic oscillation is mainly applied to the screen.

An actuator element or a shaker, respectively, are not illustrated in the figures, by means of which a flow-influencing rotary and/or vertical oscillation of the metering disk can be generated. A vertical pulsating of the disk can be attained by means of a linear oscillator, whereby an up and down movement is transferred to the particles of the conveying medium. A movement pointing in the radial direction (outwardly) is preferably transferred to the particles by means of a right-left alternating rotational deflection of the disk.

The screening system 20 comprises a screening system inlet 24 comprising a hopper 25, which forms a positioning means or a positioning aid or guide aid, respectively, for the bulk material. A feeding system 1′, via which the bulk material is fed to a feeding hopper 26 connected upstream of the screen 3, is assigned to the screening system inlet 24. The feeding system 1′ comprises a conveyor channel 6′, which is formed in a hopper-like manner, for a section of the transport path 5′ of the bulk material, which comprises the inlet means 4′ of the feeding system 1′. An outlet gap 14′, which can be changed with respect to its dimensions, is located between the hopper outlet 27 and the round metering disk 9′, which is arranged downstream therefrom. The dimensions of the outlet gap 14′ are changed by shifting the hopper 25 and/or the hopper outlet 27.

The metering disk 9′ is connected to the housing 29 via the disk holder 28 and is mechanically coupled via the holders 28 with respect to the oscillation transfer. The oscillations of the oscillation system 23 are thus also transferred to the metering disk 9′. The flow-limiting means 8′ of the feeding system 1′ is thus formed by the changeable outlet gap 14′ (gap dimension A′) and the oscillation-stimulatable metering disk 9′. The bulk material is stimulated kinetically on the transport path 5′ by means of the oscillation-induced vibration of the hopper 25 and of the metering disk 9′. On the metering disk 9′, the bulk material moves substantially in the radial direction to the outside to the edge of the disk 9′. There, the bulk materials falls over the edge 15′ into the feeding hopper 26, from where it reaches onto the screen 3. As a result of the vibration of the screen 3, large grain sizes of the bulk material reach an oversized grain outlet 32, small grain sizes reach through the screen 3 to the undersized grain outlet 31, which is separated from the oversized grain outlet 32.

An embodiment of the screening system, in which an uncoupling is provided in the area of the holders 28, by means of which the oscillation, of an oscillation system (23, 33) is not transferred to the metering disk 9′, is not illustrated in FIG. 2. Provision can be made for an additional oscillation system (11, see FIG. 1), by means of which the metering disk 9′ can be supplied with an oscillation independently from the oscillation system (23, 33). This additional oscillation system (11) of the screening system makes it possible to control the oscillation of the screen 3 and the oscillation of the metering disk 9′ separately from one another. Oscillation amplitude and/or oscillation frequency and/or oscillation modulation and/or oscillation duration on the screen 3 and/or on the metering disk 9′ can thus be adjusted, in particular separately from one another, whereby the homogeneity of the flow can be adapted to the flow behavior of the product more individually.

One or a plurality of measuring systems for measuring several flow-relevant measuring data inside the screening system 20 are also not illustrated in FIG. 2. For example the flow (volume flow) of the bulk material can belong to these measuring data. A control circuit can be supplied with the help of the measuring data, so that for instance a gap dimension (A, A′) and/or the parameters of the oscillation (amplitude, frequency, modulation) can be controlled as a function of the measured values. If the flow decreases in an undesired manner, the oscillation amplitude can be increased; should the flow decrease in an undesired manner, the oscillation amplitude could be reduced or deactivated.

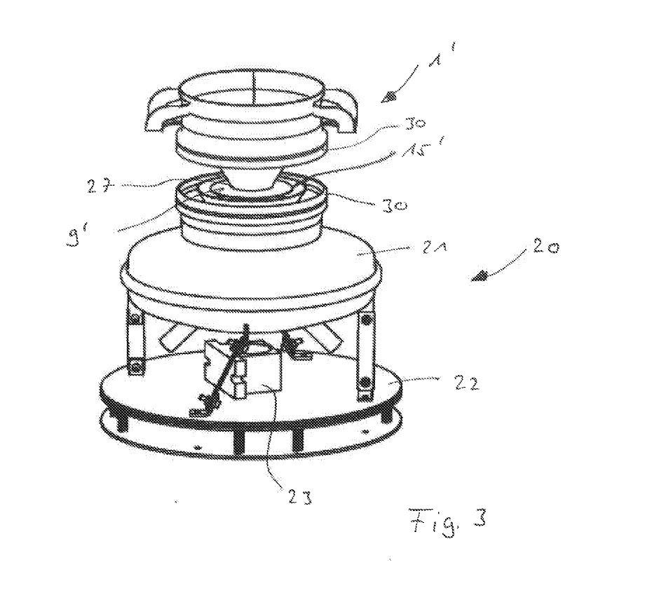

A perspective view of a screening system 20 according to FIG. 2 can be gathered from FIG. 3. The transport path of the bulk material, which substantially runs downwards, can be traced by means of FIG. 3. The bulk material is filled in on the top and exits from the system 20 again on the bottom—separated by grain size. Provision can be made in the area of the feeding system 1′ for a cylindrical window (not illustrated in FIG. 3), through which the product flow can be controlled. On the connecting rings 30, the window can be connected to the screening system. The screening system 20 can be designed in such a way that the bulk material can always be conveyed within a gas-tight or virtually gas-tight device. The screening system 20 can be capable of being filled with an inert gas, for example, so that the bulk material is conveyed in an inert gas atmosphere inside the screening system 20.

The screening system 20 according to FIGS. 2 and 3 can be an integrated or integratable (modular) part of a (modularly constructed) conveying system, by means of which the bulk material can be conveyed from a first conveying station to a second conveying station or to further conveying stations.

### LIST OF REFERENCE NUMERALS

1, 1′ feeding system
2 housing
3 screen
4, 4′ inlet means
5, 5′ transport path
6, 6′ conveyor channel
7 conveyor barrier
8, 8′ flow-limiting means
9, 9′ metering plate, metering disk
10 mechanical coupling
11 oscillation system
12 transport surface
13 end
14, 14′ outlet gap
15, 15′ flange, edge
16 outlet system
20 screening system
21 screen container
22 mass element
23 oscillation system
24 screening system inlet
25 hopper
26 feeding hopper
27 hopper outlet
28 disk holder
29 housing
30 connecting ring
31 undersized grain outlet
32 oversized grain outlet
33 ultrasonic oscillation system
A, A′ distance

1-14. (canceled)

15. A screening system for separating/screening a conveying medium formed as fluid, powder and/or bulk material, the screening system comprising a screening system inlet and at least one screening system outlet and at least one screen arranged between the screening system inlet and the at least one screening system outlet, a feeding system for feeding an associated conveying medium formed as fluid, powder and/or bulk material, which, based on a conveying direction of the associated conveying medium, is arranged upstream of at least one of the screening system inlet and the at least one screen, the feeding system comprising an inlet means and at least one outlet means;
wherein provision is made between the inlet means and the at least one outlet means for a transport path, which is delimited by means of a conveyor channel or by means of a conveyor line;
wherein a flow-limiting means, by means of which a volume flow of the associated conveying medium can be limited in a changeable manner, is arranged in or downstream from the transport path;
wherein the flow-limiting means comprises at least one flat transport surface, which is formed as a flat metering plate, wherein a metering plate edge forms the outlet means of the feeding system;
wherein the flow-limiting means comprises an outlet opening having an outlet opening size, wherein the outlet opening size can be changed to change the volume flow of the associated conveying medium, which passes through the outlet opening, wherein the outlet opening is arranged at an end of the conveyor channel or the conveyor line of the feeding system, and wherein the outlet opening is arranged between the conveyor channel or the conveyor line and the outlet means; and
wherein an oscillation can be applied to the associated conveying medium.

16. The screening system according to claim 15, wherein the outlet opening is arranged upstream of or on the transport surface.

17. The screening system according to claim 15, wherein the outlet opening size is changed by changing a distance between the conveyor channel, which leads to a transport surface or the conveyor line, which leads to the transport surface of the feeding system and of the transport surface.

18. The screening system according to claim 15, further including an electromechanically operable control circuit, which regulates the volume flow and controls the outlet opening size.

19. The screening system according to claim 15, further including a controllable and/or regulatable feeding system oscillation source, which transfers an oscillation to at least one of the feeding system, the inlet means the conveyor channel, a conveyor line, the flow-limiting means and the outlet means, which oscillation can be transferred to the associated conveying medium via at least one of the feeding system, the inlet means, the conveyor channel, the conveyor line, the flow-limiting means and the outlet means.

20. The screening system according to claim 15, further including a screening system oscillation system, by means of which a mechanical oscillation can be applied to at least one of the associated conveying medium, one or all components of the screening system, one or a plurality of components of the feeding system and the flow-limiting means, and by an ultrasonic oscillation system, by means of which an ultrasonic oscillation can be applied to at least one of the screening system, a component of the screening system and the at least one screen of the screening system.

21. The screening system according to claim 20, further including at least one controllable and/or regulatable mechanical coupling, by means of which ultrasonic oscillations can be transferred from the feeding system to at least one of the screening system inlet, the screening system outlet and the at least one screen of the screening system, and/or by means of which ultrasonic oscillations can be transferred from at least one of the screening system inlet, the screening system outlet and the at least one screen of the screening system to the feeding system.

22. The screening system according to claim 20, further including at least one uncoupling, by means of which oscillations can be blocked mechanically and/or acoustically between the feeding system and further components of the screening system.

23. The screening system according to claim 20, further including at least one mass element, which is mechanically coupled to the screening system oscillation system.

24. The screening system according to claim 15, further including a screening system housing.

25. The screening system according to claim 15, wherein the flow-limiting means, which comprises a metering plate, is arranged in or on the at least one screen or in the area of the at least one screen.

26. The screening system according to claim 20, further including a positioning means for positioning the volume flow at least one of upstream of and downstream from the feeding system.

27. A modularly constructed conveying system for conveying an associated conveying medium formed as fluid, powder and/or bulk material, including a screening system according to claim 15.

28. The conveying system according to claim 27, wherein the associated conveying medium can be conveyed in a closed environment, which contains at least an inert fluid.

29. A method for conveying a conveying medium formed as fluid, powder and/or bulk material,
wherein in one method step, the conveying medium is fed or metered in that the flow of the conveying medium is limited on the conveying path of the conveying medium, in that the conveying medium is conveyed through a conveyor passage against a conveyor barrier provided as flat metering disk,
wherein the size of the conveyor passage can be changed, and
wherein at least one of a mechanical oscillation and an ultrasonic oscillation, which can be transferred to the conveying medium, is applied to at least one of the conveyor passage and the conveyor barrier.

30. A screening system for separating/screening a conveying medium formed as fluid, powder and/or bulk material, the screening system comprising a screening system inlet and at least one screening system outlet and at least one screen arranged between the screening system inlet and the at least one screening system outlet, a feeding system for feeding an associated conveying medium formed as fluid, powder and/or bulk material, which, based on a conveying direction of the associated conveying medium, is arranged upstream of at least one of the screening system inlet and the at least one screen, the feeding system comprising an inlet means and at least one outlet means;
wherein provision is made between the inlet means and the at least one outlet means for a transport path, which is delimited by means of a conveyor channel or by means of a conveyor line;
wherein a flow-limiting means, by means of which a volume flow of the associated conveying medium can be limited in a changeable manner, is arranged in or down-stream from the transport path;
wherein the flow-limiting means comprises at least one transport surface, which is formed as a metering plate, wherein a metering plate edge portion forms the outlet means of the feeding system;
wherein the flow-limiting means comprises an outlet opening having an outlet opening size, wherein the outlet opening size can be changed to change the volume flow of the associated conveying medium, which passes through the outlet opening, wherein the outlet opening is arranged at an end of the conveyor channel or the conveyor line of the feeding system, and wherein the outlet opening is arranged between the conveyor channel or the conveyor line and the outlet means; and,
wherein an oscillation can be applied to the associated conveying medium.

31. The screening system according to claim 30, wherein the metering plate is a flat metering plate.
